(19) United States
(12) Patent Application Publication
(10) Pub. No.: US 2008/0101211 A1
(43) Pub. Date: May 1, 2008

(54) METHOD OF ASSIGNING UPLINK ACKNOWLEDGEMENT CHANNELS IN SCHEDULED PACKET DATA SYSTEMS

(76) Inventor: Anil M. Rao, Cedar Knolls, NJ (US)

Correspondence Address: MARK W. SINCELL;Williams, Morgan & Amerson, P.C., Suite 1100, 10333 Richmond, Houston, TX, 77042, US

(21) Appl. No.: 11/554,943

(22) Filed: Oct. 31, 2006

(51) Int. Cl. H04J 11/00

(52) U.S. Cl. 370/206; 370/335

(57) ABSTRACT

The present invention provides a method and apparatus for assigning uplink acknowledgement channels in scheduled packet data systems is provided. The method includes providing at least one message indicating that at least one packet is scheduled to be provided to at least one mobile unit over a downlink. The message also indicates at least one time-frequency resource for providing acknowledgment of the at least one packet on an uplink.

### BACKGROUND OF THE INVENTION

1. Field of the Invention

This invention relates generally to communication systems, and, more particularly, to wireless communication systems.

2. Description of the Related Art

Wireless communication systems typically include one or more base stations (or access points/networks) for providing wireless connectivity to mobile units in a geographic area associated with each base station. Mobile units and base stations communicate by transmitting modulated radiofrequency signals over a wireless communication link, or air interface. The air interface includes downlink (or forward link) channels for transmitting information from the base station to the mobile unit and uplink (or reverse link) channels for transmitting information from the mobile unit to the base station. The uplink and downlink channels are typically divided into data channels, random access channels, broadcast channels, paging channels, control channels, and the like. Information is transmitted over the uplink and downlink according to one or more communication protocols and/or standards. For example, the Third Generation Partnership Project (3GPP) has defined standards, such as the Universal Mobile Telecommunication System (UMTS) standard and the 3GPP Long Term Evolution (LTE) standard, which implement protocols such as the Code Division Multiple Access (CDMA, CDMA-2000) and Orthogonal Frequency Division Multiplexing (OFDM) protocols.

The 3GPP LTE standard uses a variant of OFDM in the reverse link called the single-channel frequency division multiple access (SC-FDMA) protocol. In SC-FDMA, groups of subcarriers are assigned to a user at every scheduling instant. User orthogonality is maintained in an OFDM system by requiring each user to send control and data channel information over a unique time-frequency resource, e.g., at a particular time and using a particular set of frequencies (or subcarriers). In contrast, in CDMA all users transmit both their data channels and control channels concurrently over the entire transmission bandwidth (which is about 5 MHz in UMTS). Thus, one of the key differences between an OFDM based reverse link and an existing CDMA based reverse link (e.g., as reverse link as defined in Release 6 of the UMTS standards) is that the uplink transmissions from different users in OFDM are required to be transmitted on non-overlapping bandwidth.

One of the main challenges in the OFDM system is the allocation of time-frequency resources for users control channel signaling in the reverse link. Unlike CDMA, in which a control channel is just transmitted at any time over the entire bandwidth using a unique spreading and scrambling code, in OFDM time-frequency resources must be allocated to each user for the transmission of uplink control signaling. One control channel of particular importance is the UpLink ACKnowledgment CHannel (UL-ACKCH). This channel carries ACK/NACK information that is used to support Hybrid Automatic Repeat reQuest (HARQ) transmissions on the downlink. The ACK/NACK information on the reverse link is typically transmitted at a fixed time offset from the time the user receives the downlink packet transmission (e.g., the ACK/NACK could be sent in the text transmission time interval, which translates into an offset of about 1 ms or 2 ms).

The simplest method of allocation the UL-ACKCH is to pre-allocate time-frequency resources for each user in the system. For example, a unique set of subcarriers in every transmission time interval could be allocated to each user for the user's UL-ACKCH. However, there are several problems with this conventional approach: First, pre-allocation of time-frequency resources to the UL-ACKCH does not scale well with the number of users because the proportion of the total resources that must be set aside, and therefore cannot be used for regular data transmissions, increases in proportion to the number of users. Thus, the traffic capacity of the system may be reduced as more and more users are added to the system and more of the time-frequency resources are consumed by reserved acknowledgement channels. Second, when the user is not scheduled in the downlink, it has no information to send on the UL-ACKCH, and hence the reserved resource is wasted.

Different users may require different sized time-frequency allocations for the UL-ACKCH. For example, users at the edge of the cell may experience poor signal-to-interference-plus-noise (SINR) conditions. Compared to a user who is close to the Node-B and is experiencing good SINR conditions, these edge users may need a relatively large time-frequency allocation for the UL-ACKCH so that increased redundancy information can be added. Motion of the user and changing environmental conditions typically cause the SINR of each user to fluctuate. Consequently, a pre-allocation scheme would either have to assign the largest time-frequency allocation to all users, which is wasteful of resources, or would have to constantly reconfigure the time-frequency allocation for the UL-ACKCH based on the user's SINR conditions.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for assigning uplink acknowledgement channels in scheduled packet data systems. The method includes providing at least one message indicating that at least one packet is scheduled to be provided to at least one mobile unit over a downlink. The message also indicates at least one time-frequency resource for providing acknowledgment of the at least one packet on an uplink.

In another embodiment of the present invention, a method is provided for assigning uplink acknowledgement channels in scheduled packet data systems. The method includes receiving at least one message indicating that at least one packet is scheduled to be provided over a downlink. The message also indicates at least one time-frequency resource for providing acknowledgment of the at least one packet on an uplink.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention; and

FIG. 2 conceptually illustrates one exemplary embodiment of a grid of time-frequency resources, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

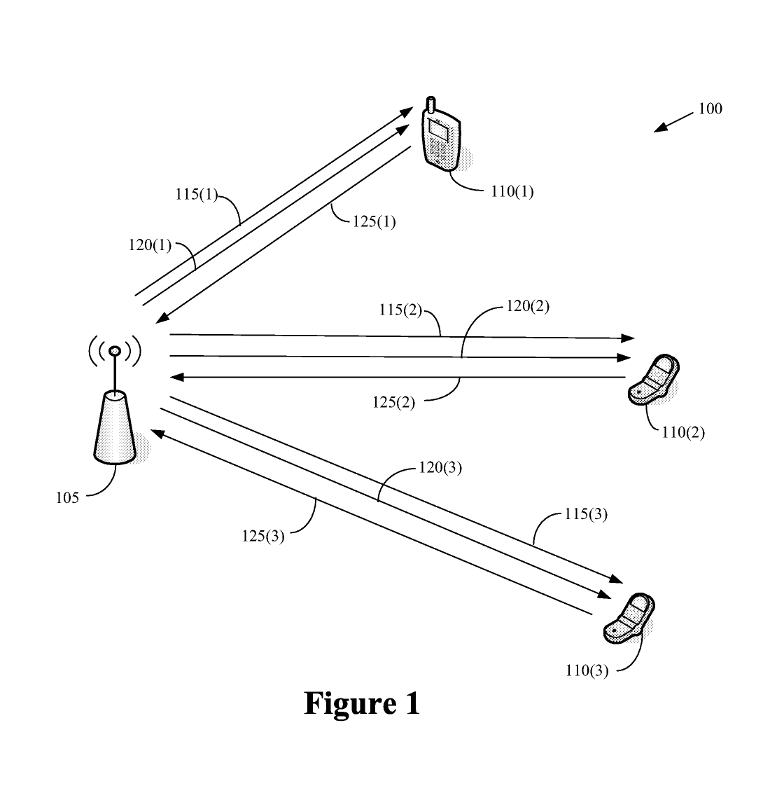

FIG. 1 conceptually illustrates one exemplary embodiment of a wireless communication system 100. In the illustrated embodiment, the wireless communication system 100 includes a base station 105 for providing wireless connectivity. However, persons of ordinary skill in the art having benefit of the present disclosure should appreciate that the present invention is not limited to a wireless communication system 100 that includes a base station 105. In alternative embodiments, other devices or combinations of devices may be used to provide wireless connectivity. For example, the wireless communication system 100 may include one or more access points, access networks, base station routers, and the like. In the illustrated embodiment, the base station 105 provides wireless connectivity according to the 3GPP LTE standard. However, the present invention is not limited to operation according to this standard and in alternative embodiments other standards may also be implemented in addition to or in place of this standard.

One or more mobile units 110(1-3) may access the wireless communication system 100 by forming communication links with the base station 105 over the air interface. The indices (1-3) may be used to refer to the mobile units 110(1-3) individually or in subsets. However, these indices may be dropped when the mobile units 110 are referred to collectively. This convention may also be applied to other elements in the drawings that are referred to by a numeral and one or more distinguishing indices. Furthermore, although a single base station 105 and three mobile units 110 are shown in FIG. 1, persons of ordinary skill in the art having benefit of the present disclosure should appreciate that the present invention is not limited to these numbers and in alternative embodiments any number of base stations 105 and/or mobile units 110 may be included in the wireless communication system 100.

The air interface between the mobile units 110 and the base station 105 supports a downlink grant channel 115, a downlink shared channel 120, and an uplink acknowledgment channel 125. The air interface also supports other channels but, in the interest of clarity, these channels are not depicted in FIG. 1. In the illustrated embodiment, the downlink grant channel 115 carries messages that indicate when a mobile unit 110 is scheduled to receive packets on the downlink. These messages may be referred to as scheduling grant messages. The downlink shared channels 120 carry the data that is being transmitted to the mobile units 110, as indicated in the scheduling grants. Mobile units 110 use the uplink acknowledgment channel 125 to transmit acknowledgement messages indicating whether or not the data transmitted on the downlink shared a channel 120 was successfully received. For example, the mobile units 110 may transmit a positive acknowledgment (ACK) if the transmitted packets were successfully received and decoded and the mobile units 110 may transmit a negative acknowledgment (NACK) if one or more transmitted packets was not successfully received and/or decoded.

Scheduling grant messages transmitted on the downlink grant channel 115 also include information that indicates, either implicitly or explicitly, the time-frequency resources that the mobile units 110 may use in the uplink direction to send the ACK/NACK information corresponding to the downlink packet transmission indicated in the scheduling grant message. For each downlink packet transmission on the downlink shared channel 120, the downlink grant channel 115 may carry a message, such as a scheduling grant, that includes information indicating which mobile units 110 have been scheduled. The message may also indicate the packet format used by packets that are carried on the downlink channels 115, 120. When the mobile units 110 receive the downlink packet transmissions indicated in the message, the mobile units 110 attempt to decode the packets. If the decoding attempt is successful, then the mobile units 110 may transmit an ACK on the uplink channel using the time-frequency resources indicated in the message. If the decoding attempt is not successful, then the mobile units 110 may transmit a NACK on the uplink channel using the time-frequency resources indicated in the message.

The time-frequency resources of the air interface may be conserved by transmitting information indicating the time-frequency resources that the mobile units 110 may use for transmitting ACK/NACK messages. Mobile units 110 only have information to send on the uplink acknowledgement channel 125 when data has been sent to that mobile unit 110 over the downlink shared channel 120 as indicated by the message transmitted over the downlink grant channel 115. Thus, when the mobile unit 110 is not scheduled in the downlink, it typically has no information to send on the uplink acknowledgement channel. Hence it is much more efficient to allocate time-frequency resources for the uplink acknowledgement channel only when resources for this channel are needed, e.g. in response to scheduling that mobile unit 110 to receive a downlink packet.

In one embodiment, a set of time-frequency resources may be reserved to be used by all downlink scheduled mobile units 110 to transmit the uplink acknowledgement channel. However, individual mobile units 110 are not allocated any of the time-frequency resources until they are scheduled to receive one or more downlink packets. This contrasts with conventional practice in which each user is assigned in advance a time-frequency resource to use for its uplink acknowledgement channel. Since the wireless communication system 100 only needs to pre-allocate enough resources to support uplink acknowledgment transmissions by scheduled mobile units 110, the amount of resources that are pre-allocated may be significantly less than would be necessary to pre-allocate resources to all of the mobile units 110 in the wireless communication system 100. As an example, in 3GPP LTE, the downlink allocation scheme is limited to scheduling a maximum of 25 users simultaneously in a cell with a 5 MHz transmission bandwidth. However it is envisioned that several hundred users can be active in a cell. So while conventional pre-allocation techniques would have had to pre-allocate resources for several hundred users, the technique described herein only needs to pre-allocate resources for 25 users.

The time-frequency resources may include transmission time intervals and subcarrier frequencies that are allocated to the mobile units 110 for transmitting uplink acknowledgment messages. For example, the time-frequency resources may be defined as a number of transmission time intervals available for each subcarrier supported by the base station 105. However, the present invention is not limited to time-frequency resources that are divided into transmission time intervals and subcarriers. In one alternative embodiment, the time-frequency resources may be divided using transmission time intervals and code sequences. In one embodiment, each unit of the time-frequency resource may have an associated identifier, such as a time-frequency unit identifier, a code sequence identifier, and the like.

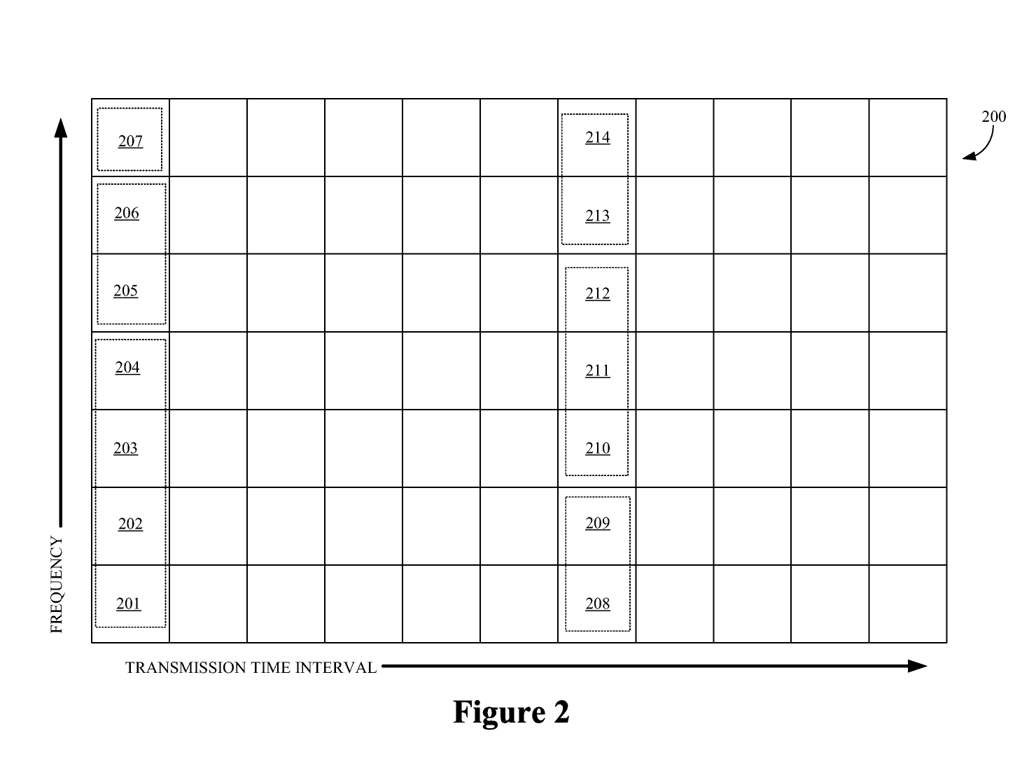

FIG. 2 conceptually illustrates one exemplary embodiment of a grid 200 of time-frequency resources. In the illustrated embodiment, the horizontal axis indicates transmission time intervals and the vertical axis indicates the frequency of the subcarrier. The time-frequency resource units 201-214 have been reserved for transmitting uplink acknowledgment messages and may be allocated to individual mobile units when these mobile units are scheduled to receive packets on the downlink. For example, the time-frequency resource units 201-204 may be allocated to a first mobile unit, the time-frequency resource units 205-206 may be allocated to a second mobile unit, the time-frequency resource unit 207 may be allocated to a third mobile unit, the time-frequency resource units 208-209 may be allocated to a fourth mobile unit, the time-frequency resource units 210-212 may be allocated to a fifth mobile unit, and the time-frequency resource units 213-214 may be allocated to a sixth mobile unit.

In one embodiment, the number of time-frequency resource units that are allocated to each mobile unit may be determined based upon a signal-to-interference-plus-noise (SINR) condition for the mobile unit. For example, four time-frequency resource units may be allocated to the first mobile unit because the first mobile unit is located near the edge of a cell and therefore has a relatively small SINR. Allocating four time-frequency resource units to the first mobile unit allows the first mobile unit to add more protection to the ACK/NACK transmission. In contrast, a single time-frequency resource unit may be allocated to the third mobile unit because the third mobile unit is located relatively close to a transmitting base station and therefore has a relatively large SINR.

The allocation of the time-frequency resources may be indicated explicitly in the scheduling grant message. For example, the downlink grant channel may transmit specific information that tells each mobile unit which of the pre-allocated time-frequency resources to use for its uplink acknowledgement channel transmission. This can be done by conveying an index together with the number of time-frequency units to use. For example, the scheduling grant message may instruct the first mobile unit to transmit uplink acknowledgments using the first time-frequency resource unit 201 and to continue transmitting uplink acknowledgments using four consecutive time-frequency resource units 201-204. Note that the downlink scheduler can decide in advance the maximum number of mobile units to schedule in the downlink, based on the requirements of time-frequency resource units needed by the uplink acknowledgment channel for all mobile units scheduled in the downlink. For example, if the downlink scheduler decides it needs to schedule mobile units who have poor SINR conditions in the uplink, then it may decide to schedule a small number of these mobile units because each mobile unit may require several time-frequency units in the uplink in order to transmit the corresponding ACK/NACK information on the uplink acknowledgment channel.

Alternatively, the allocation of the time-frequency resources may be indicated implicitly in the scheduling grant message. In one embodiment, the starting time-frequency unit index for each user may be indicated implicitly by the ordering of users in the scheduling grant message, i.e., each mobile unit can map the ordering of the mobile units in the scheduling grant message to the starting time-frequency unit index. For example, if two time-frequency resource units are allocated to each mobile unit and the scheduling grant message lists the third mobile unit, the first mobile unit, and the second mobile unit, then each mobile unit can infer that the third mobile unit should transmit uplink acknowledgments in the time-frequency resource units 201-202, the first mobile unit should transmit in the time-frequency resource units 203-204, and the second mobile unit should transmit in the time-frequency resource units 205-206.

The scheduling grant message may also indicate the number of time-frequency resource units that are allocated to each mobile unit. In that case, the time-frequency resource units that are allocated to each mobile unit may be determined using the ordering of the mobile units and the allocated numbers of time-frequency resource units. For example, if the scheduling grant message intends to indicate the resource allocation shown in FIG. 2, then the scheduling grant message would list the first mobile unit with an indication that the first mobile unit has been allocated four time-frequency resource units, the second mobile unit with an indication that the second mobile unit has been allocated two time-frequency resource units, the third mobile unit with an indication that the third mobile unit has been allocated one time-frequency resource unit, the fourth mobile unit with an indication that the fourth mobile unit has been allocated two time-frequency resource units, the fifth mobile unit with an indication that the fifth mobile unit has been allocated three time-frequency resource units, and the sixth mobile unit with an indication that the sixth mobile unit has been allocated two time-frequency resource units. This approach may reduce the number of bits that are needed to convey the allocation of the uplink acknowledgment channel resources. For example, the downlink grant channel only needs to convey enough bits to indicate the largest size of the time-frequency resource, e.g., 2 bits could indicate up to 4 time-frequency resource units.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
providing at least one message indicating that at least one packet is scheduled to be provided to at least one mobile unit over a downlink and indicating at least one time-frequency resource for providing acknowledgment of said at least one packet on an uplink.

2. The method of claim 1, wherein providing said at least one message comprises providing at least one message indicating at least one transmission time interval and at least one subcarrier for providing the acknowledgement.

3. The method of claim 2, wherein providing said at least one message comprises providing at least one message indicating at least one transmission time interval selected from a plurality of transmission time intervals associated with said at least one mobile unit and at least one subcarrier selected from a plurality of subcarriers associated with said at least one mobile unit.

4. The method of claim 2, wherein providing said at least one message comprises providing at least one message including an explicit indication of said at least one transmission time interval and at least one subcarrier.

5. The method of claim 4, wherein providing said at least one message including the explicit indication of said at least one transmission time interval and said at least one subcarrier comprises providing at least one message including at least one index indicative of said at least one transmission time interval and said at least one subcarrier and at least one number of transmission time intervals and subcarriers.

6. The method of claim 2, wherein providing said at least one message comprises providing at least one message including an implicit indication of said at least one transmission time interval and at least one subcarrier.

7. The method of claim 6, wherein providing said at least one message including an implicit indication of said at least one transmission time interval and said at least one subcarrier comprises providing an ordered list of the mobile units scheduled to receive said at least one packet.

8. The method of claim 1, wherein providing said at least one message comprises providing at least one message indicating at least one code sequence for providing the acknowledgement.

9. The method of claim 1, comprising determining said at least one time-frequency resource based on at least one signal-to-interference-plus-noise (SINR) condition associated with at least one mobile unit.

10. The method of claim 1, comprising receiving said at least one acknowledgment transmitted by said at least one mobile unit over the uplink using the indicated time-frequency resource.

11. A method, comprising:
receiving at least one message indicating that at least one packet is scheduled to be provided over a downlink and indicating at least one time-frequency resource for providing acknowledgment of said at least one packet on an uplink.

12. The method of claim 11, wherein receiving said at least one message comprises receiving at least one message indicating at least one transmission time interval and at least one subcarrier for providing the acknowledgement.

13. The method of claim 12, wherein receiving said at least one message comprises receiving at least one message indicating at least one transmission time interval and at least one subcarrier selected from a plurality of transmission time intervals and a plurality of subcarriers associated with at least one mobile unit.

14. The method of claim 12, wherein receiving said at least one message comprises receiving at least one message including an explicit indication of said at least one transmission time interval and at least one subcarrier.

15. The method of claim 14, wherein receiving said at least one message including the explicit indication of said at least one transmission time interval and said at least one subcarrier receiving at least one message including at least one index indicative of said at least one transmission time interval and said at least one subcarrier and at least one number of transmission time intervals and subcarriers.

16. The method of claim 12, wherein receiving said at least one message comprises receiving at least one message including an implicit indication of said at least one transmission time interval and at least one subcarrier.

17. The method of claim 16, wherein receiving said at least one message including an implicit indication of said at least one transmission time interval and said at least one subcarrier comprises receiving an ordered list of the mobile units scheduled to receive said at least one packet.

18. The method of claim 11, wherein receiving said at least one message comprises receiving at least one message indicating at least one code sequence for providing the acknowledgement.

19. The method of claim 11, wherein receiving said at least one message comprises receiving at least one message indicating at least one transmission time interval and at least one subcarrier for providing the acknowledgement selected based on at least one signal-to-interference-plus-noise (SINR) condition.

20. The method of claim 11, comprising providing said at least one acknowledgment over the uplink using the indicated time-frequency resource.
